(19) United States
(12) Patent Application Publication
(10) Pub. No.: US 2024/0301533 A1
(43) Pub. Date: Sep. 12, 2024

(54) METAL RECOVERY SYSTEM AND METAL RECOVERY METHOD

(71) Applicant: HONDA MOTOR CO., LTD., Tokyo (JP)

(72) Inventors: Takahiro Tsuchiyama, Wako-shi (JP); Daisuke Kurashina, Wako-shi (JP); Kenichi Toya, Wako-shi (JP); Kenji Fujiki, Wako-shi (JP)

(21) Appl. No.: 18/435,126

(22) Filed: Feb. 7, 2024

(30) Foreign Application Priority Data
Mar. 9, 2023 (JP) 2023-036855

(51) Int. Cl. C22B 26/12; B01D 61/08; B01D 61/46; B01D 61/54; B01D 61/58; B01J 47/12; B01J 47/14; C02F 1/44; C02F 103/08; C22B 3/02; C22B 3/22; C22B 3/42

(52) U.S. Cl. CPC C22B 26/12; B01D 61/08; B01D 61/46; B01D 61/54; B01D 61/58; B01J 47/12; B01J 47/14; C02F 1/441; C22B 3/02; C22B 3/22; C22B 3/42; B01D 2311/08; B01D 2311/103; B01D 2311/16; B01D 2311/246; B01D 2311/2603; B01D 2311/2623; B01D 2313/243; C02F 2103/08

(57) ABSTRACT

A metal recovery system includes: a desalination apparatus obtaining freshwater with a reverse osmosis membrane from liquid to be processed pressurized by a pump; a metal recovery apparatus recovering metal ions from first drainage from the desalination apparatus, using a metal ion exchange membrane; and a control apparatus that includes: a pump control unit controlling energization of the pump so that an inflow flow rate of the liquid to be processed flowing into the desalination apparatus is a predetermined first flow rate when an exchange membrane temperature is within a temperature range determined in advance; and an exchange membrane control unit controlling energization of electrodes applying an electric field to a metal ion exchange membrane based on a first ion concentration that is a concentration of the metal ions in the first drainage when the exchange membrane temperature is within a temperature range determined in advance.

### INCORPORATION BY REFERENCE

The present application claims priority under 35 U.S.C. § 119 to Japanese Patent Application No. 2023-036855 filed on Mar. 9, 2023. The content of the application is incorporated herein by reference in its entirety.

### BACKGROUND OF THE INVENTION

### Field of the Invention

The present invention relates to a metal recovery system and a metal recovery method.

### Description of the Related Art

Research and development has been recently conducted on secondary batteries that contribute to energy efficiency, to ensure that more people have access to affordable, reliable, sustainable, and advanced energy.

Furthermore, lithium (Li) has recently increased importance in industry as a material to be used in the production of lithium ion batteries and fuel for nuclear fusion reactors.

Japanese Patent Laid-Open No. 2017-131863 discloses a lithium recovery apparatus using a selectively permeable membrane made of a lithium ion conductor (ion conductor) such as lithium lanthanum titanate. In this lithium recovery apparatus, a selectively permeable membrane in a flat plate shape partitions a processing tank into two spaces, and mesh electrodes provided on opposite main surfaces of the selectively permeable membrane apply an electric field between the main surfaces, so that lithium ions in the seawater are recovered from the seawater introduced into one compartment of the above partitioned processing tank to a recovery liquid filling the other compartment.

Japanese Patent No. 5974386 discloses a seawater desalination system that uses an RO membrane (reverse osmosis membrane) to remove impurities from seawater and obtain freshwater.

In technology related to secondary batteries, it is a challenge to secure a stable and abundant supply of metals such as lithium (Li), which are the materials for secondary batteries. In contrast, the above two conventional techniques both process seawater, but each process performs a single process of seawater processing: lithium ion recovery or seawater desalination, and there is room for improvement in terms of efficient resource extraction from seawater.

An object of the present application is to realize a metal recovery system that can efficiently recover above specific metals from liquid to be processed such as seawater that contain ions of the specific metals to be recovered such as Li, as well as desalinate the liquid to be processed, in order to solve the above problem. The apparatus and the method will eventually contribute to efficiency improvement of energy.

### SUMMARY OF THE INVENTION

An aspect of the present invention is a metal recovery system including: a pump that pressurizes and sends out liquid to be processed; a desalination apparatus that obtains freshwater with a reverse osmosis membrane from the liquid to be processed pressurized by the pump; a metal recovery apparatus that recovers metal ions of a targeted specific metal from first drainage that is drainage liquid discharged from the desalination apparatus out of the liquid to be processed, using a metal ion exchange membrane; a flow rate sensor that detects an inflow flow rate of the liquid to be processed flowing from the pump into the desalination apparatus; a temperature sensor that detects an exchange membrane temperature that is a temperature of the metal ion exchange membrane; a first concentration sensor that detects a first ion concentration that is a metal ion concentration of the specific metal in the first drainage; and a control apparatus that controls: energization of electrodes that apply an electric field to the metal ion exchange membrane; and energization of the pump, in which the control apparatus includes: a pump control unit that controls energization of the pump so that the inflow flow rate is a first flow rate, determined in advance, when the exchange membrane temperature is within a predetermined temperature range determined in advance; and an exchange membrane control unit that controls energization of the electrodes based on the first ion concentration when the exchange membrane temperature is within a predetermined temperature range determined in advance.

According to another aspect of the present invention, the metal recovery system further includes: a second concentration sensor that detects a second ion concentration that is a metal ion concentration of the specific metal in second drainage that is drainage liquid discharged from the metal recovery apparatus out of the first drainage; a drainage path that drains the second drainage; a reflux path that refluxes the second drainage to a suction port of the pump; and a control valve that controls whether the second drainage flows into the reflux path or into the drainage path, in which the control apparatus further includes a valve control unit that controls operation of the control valve, and the valve control unit: controls the control valve so that the second drainage flows to the reflux path when the second ion concentration is equal to or higher than a concentration threshold determined in advance and the exchange membrane temperature is equal to or lower than an upper limit temperature of the predetermined temperature range; and controls the control valve so that the second drainage flows to the drainage path when the second ion concentration is less than a concentration threshold determined in advance or the exchange membrane temperature is above the predetermined temperature range.

According to yet another aspect of the present invention, the pump control unit controls energization of the pump so that the inflow flow rate is a second flow rate that is lower than the first flow rate when the exchange membrane temperature is lower than the predetermined temperature range, and the exchange membrane control unit controls energization of the electrodes so that a temperature rise rate per hour of the exchange membrane temperature is within a range, determined in advance, when the exchange membrane temperature is lower than the predetermined temperature range.

According to yet another aspect of the present invention, the second flow rate is set to a value that monotonically increases at a predetermined flow rate increase rate with respect to the exchange membrane temperature or time, and when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

According to yet another aspect of the present invention, the pump control unit controls energization of the pump so that the inflow flow rate is a third flow rate that is higher than the first flow rate when the exchange membrane temperature is higher than the predetermined temperature range.

According to yet another aspect of the present invention, the specific metal is lithium.

According to yet another aspect of the present invention, the liquid to be processed is seawater.

Another aspect of the present invention is a metal recovery method executed by a computer of a metal recovery system including: a pump that pressurizes and sends out liquid to be processed; a desalination apparatus that obtains freshwater with a reverse osmosis membrane from the liquid to be processed pressurized by the pump; a metal recovery apparatus that recovers metal ions of a targeted specific metal from first drainage that is drainage liquid discharged from the desalination apparatus out of the liquid to be processed, using a metal ion exchange membrane; a flow rate sensor that detects an inflow flow rate of the liquid to be processed flowing from the pump into the desalination apparatus; a temperature sensor that detects an exchange membrane temperature that is a temperature of the metal ion exchange membrane; a first concentration sensor that detects a first ion concentration that is a metal ion concentration of the specific metal in the first drainage; a control apparatus that controls: energization of electrodes that apply an electric field to the metal ion exchange membrane; and energization of the pump, which method includes: a first pump control step of controlling energization of the pump so that the inflow flow rate is a predetermined first flow rate when the exchange membrane temperature is within a temperature range determined in advance; and a first exchange membrane control step of controlling energization of the electrodes based on the first ion concentration when the exchange membrane temperature is within a predetermined temperature range determined in advance.

According to yet another aspect of the present invention, the metal recovery system further includes: a second concentration sensor that detects a second ion concentration that is a metal ion concentration of the specific metal in second drainage that is drainage liquid discharged from the metal recovery apparatus out of the first drainage; a drainage path that drains the second drainage; a reflux path that refluxes the second drainage to a suction port of the pump; and a control valve that controls whether the second drainage flows into the reflux path or into the drainage path, and the metal recovery method further includes a reflux control step of: controlling the control valve so that the second drainage flows to the reflux path when the second ion concentration is equal to or higher than a concentration threshold determined in advance and the exchange membrane temperature is equal to or lower than an upper limit temperature of the predetermined temperature range; and controlling the control valve so that the second drainage flows to the drainage path when the second ion concentration is less than a concentration threshold determined in advance or the exchange membrane temperature is above the predetermined temperature range.

According to yet another aspect of the present invention, the metal recovery method further includes: a second pump control step of controlling energization of the pump so that the inflow flow rate is a second flow rate that is lower than the first flow rate when the exchange membrane temperature is lower than the predetermined temperature range; and a second exchange membrane control step of controlling energization of the electrodes so that a temperature rise rate per hour of the exchange membrane temperature is within a range, determined in advance, when the exchange membrane temperature is lower than the predetermined temperature range.

According to yet another aspect of the present invention, the second flow rate is set to a value that monotonically increases at a predetermined flow rate increase rate with respect to the exchange membrane temperature or time, and when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

According to yet another aspect of the present invention, the metal recovery method further includes a third pump control step of controlling energization of the pump so that the inflow flow rate is a third flow rate that is higher than the first flow rate when the exchange membrane temperature is higher than the predetermined temperature range.

According to the aspect of the present invention, the above specific metal can be efficiently recovered from a liquid to be processed, such as seawater, containing ions of a specific metal to be recovered, and the liquid to be processed can also be desalinated.

### BRIEF DESCRIPTION OF THE DRAWINGS

FIG. 1 is a diagram showing a configuration of a metal recovery system according to an embodiment of the present invention;

FIGS. 2A to 2E are diagrams showing an example of operation of the metal recovery system; and

FIG. 3 is a flowchart showing a processing procedure of a metal recovery method executed by the metal recovery system.

### DETAILED DESCRIPTION OF THE PREFERRED EMBODIMENTS

The following describes embodiments of the present invention with reference to drawings.

### 1. Configuration of Metal Recovery System

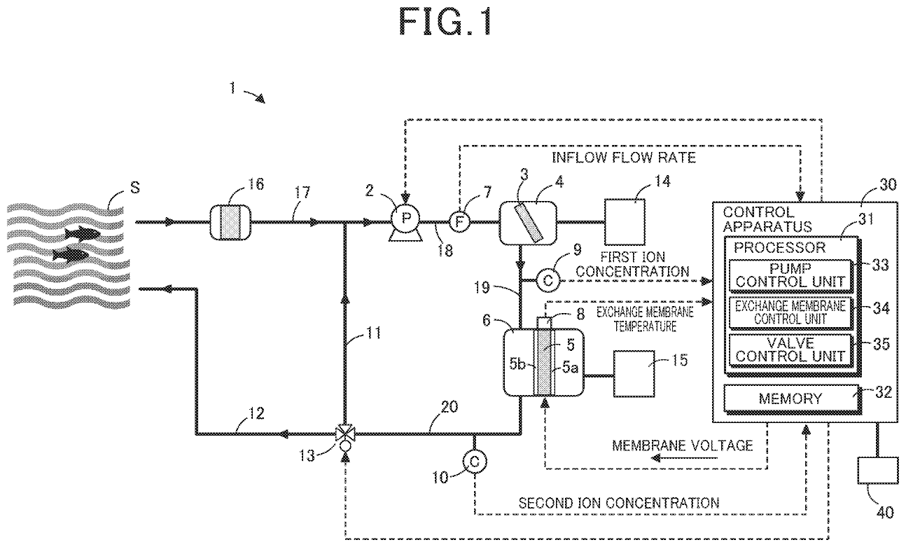

FIG. 1 is a diagram showing a configuration of a metal recovery system 1 according to an embodiment of the present invention. The metal recovery system 1 obtains freshwater from a liquid to be processed, and also recovers metal ions of a specific metal to be recovered from the liquid to be processed. In the present embodiment, for example, the liquid to be processed is seawater taken from the sea S, and the specific metal to be recovered is lithium (Li).

The metal recovery system 1 includes: a pump 2 that pressurizes and sends out a liquid to be processed; a desalination apparatus 4 that obtains freshwater from the liquid to be processed pressurized by the pump 2, through a reverse osmosis membrane 3; and a metal recovery apparatus 6 that recovers metal ions of a specific metal to be recovered from first drainage, which is drainage liquid discharged from the desalination apparatus 4 out of the liquid to be processed, using a metal ion exchange membrane 5.

The desalination apparatus 4 obtains freshwater from the liquid to be processed using a known reverse osmosis membrane 3 according to a conventional technique (for example, the technique described in Japanese Patent No. 5974386). Furthermore, the metal recovery apparatus 6 energizes the electrodes 5a and 5b provided on a known metal ion exchange membrane 5, to apply an electric field to the metal ion exchange membrane 5, thereby recovering metal ions from the liquid to be processed, according to the conventional technique (for example, the technique described in Japanese Patent Laid-Open No. 2017-131863 described above). In the present embodiment, the metal ion exchange membrane 5 is a lithium ion exchange membrane that recovers lithium ions.

For example, the freshwater obtained from the liquid to be processed in the desalination apparatus 4 is stored in the freshwater storage tank 14, and the recovery liquid containing metal ions recovered by the metal recovery apparatus 6 is stored in the recovery liquid storage tank 15. The metal ions contained in the recovery liquid stored in the recovery liquid storage tank 15 are extracted as a metal compound or a simple metal in a post-processing step according to conventional techniques.

The metal recovery system 1 also includes a flow rate sensor 7 that detects a flow rate of the liquid to be processed flowing into the desalination apparatus 4 from the pump 2, a temperature sensor 8 that detects an exchange membrane temperature that is the temperature of the metal ion exchange membrane 5, and a first concentration sensor 9 that detects a first ion concentration that is the metal ion concentration of the above specific metal in the first drainage. The metal recovery system 1 also includes a second concentration sensor 10 that detects a second ion concentration that is a metal ion concentration of the above specific metal in second drainage. The second drainage is drainage liquid passing through the metal recovery apparatus 6 and then discharged from the metal recovery apparatus 6 out of the first drainage discharged from the desalination apparatus 4.

The metal recovery system 1 also includes a reflux path 11 that refluxes the second drainage to the suction port of the pump 2, a drainage path 12 that returns the second drainage to the sea S, and a control valve 13 that controls whether the second drainage flows into the reflux path 11 or the drainage path 12. The control valve 13 is, for example, an electromagnetic valve including an actuator to switch the flow path.

In FIG. 1, seawater from the sea S, the foreign matter of which is removed by a mesh filter 16 inserted into a water intake pipe 17, and then flows into the suction port of the pump 2 as a liquid to be processed. The pump 2 pressurizes the liquid to be processed and discharges it from the discharge port, and causes the pressurized liquid to be processed to flow into the desalination apparatus 4 via the inflow pipe 18. The first drainage discharged from the desalination apparatus 4 flows into the metal recovery apparatus 6 via the communication pipe 19. The second drainage discharged from the metal recovery apparatus 6 flows into the control valve 13 through the drainage pipe 20, and then is refluxed to the suction port of the pump 2 through the reflux path 11 or returned to the sea through the drainage path 12. Specifically, the reflux path 11 and the drainage path 12 are conduits made of pipes or tubes similar to the water intake pipe 17 and the like.

Here, the desalination apparatus 4 and the metal recovery apparatus 6 are connected in series by the communication pipe 19 as described above. Therefore, controlling the energization of one pump 2 allows control of the flow rate of the liquid to be processed flowing into the desalination apparatus 4, and control of the flow rate of the first drainage flowing from the desalination apparatus 4 into the metal recovery apparatus 6.

The metal recovery system 1 further includes a control apparatus 30 that controls: energization of the electrodes 5a and 5b for applying an electric field to the metal ion exchange membrane 5 of the metal recovery apparatus 6; energization of the pump 2; and the flow path switching of the control valve 13.

The metal recovery system 1 having the above configuration extracts freshwater from the liquid to be processed with the desalination apparatus 4, and allows the first drainage to flow into the metal recovery apparatus 6, which first drainage is the drainage from the desalination apparatus 4 and has a rich metal ion content per unit volume because the freshwater has been extracted. Therefore, the metal recovery apparatus 6 can efficiently recover the metal to be recovered from the first drainage. As a result, the metal recovery system 1 can simultaneously realize desalination of the liquid to be processed and efficient metal recovery from the liquid to be processed.

### 2. Control Apparatus

The following describes the control apparatus 30 that configures the metal recovery system 1.

With reference to FIG. 1, the control apparatus 30 is connected to an operator terminal 40 (computer) operated by an operator of the metal recovery system 1. The operator terminal 40 includes, for example, a touch panel. The operator terminal 40 inputs an operation instruction, such as an operation start instruction or an operation stop instruction for the metal recovery system 1, inputted by the operator to the control apparatus 30. The operator terminal 40 may display a monitoring screen showing the operation state of the metal recovery system 1 (for example, sensor data of each sensor such as the flow rate sensor 7, and the state of the control valve 13) based on the instruction from the control apparatus 30.

The control apparatus 30 includes a processor 31 and a memory 32. The memory 32 is configured with, for example, volatile and/or nonvolatile semiconductor memory, and/or a hard disk device.

The processor 31 is, for example, a computer including a CPU. The processor 31 may have a ROM in which a program is written, a RAM for temporarily storing data, and the like. The processor 31 includes a pump control unit 33, an exchange membrane control unit 34, and a valve control unit 35 as functional elements or functional units.

The pump control unit 33 controls energization of the pump 2. Furthermore, the exchange membrane control unit 34 controls energization of the electrodes 5a and 5b that apply an electric field to the metal ion exchange membrane 5. The valve control unit 35 controls the control valve 13 to switch the flow path of the second drainage to the drainage path 12 or the reflux path 11.

These functional elements included in the processor 31 are realized, for example, by the processor 31, which is a computer, executing a program stored in the memory 32. Note that the program can be stored in any computer-readable storage medium. Alternatively, all or part of the above functional elements included in the processor 31 may be configured by hardware each including one or more electronic circuit components.

The operation of the control apparatus 30 is divided into warm-up operation, normal operation, and restoration operation. The warm-up operation is operation of the metal recovery system 1 in the warm-up period from the start of operation until the exchange membrane temperature acquired by the temperature sensor 8 reaches a predetermined operating temperature range determined in advance (hereinafter also referred to as a predetermined temperature range). Normal operation is operation in a rated operating state in which the exchange membrane temperature has risen to the above-mentioned predetermined temperature range. The restoration operation is operation for restoring a rated operating state from an abnormal state in which the exchange membrane temperature has risen beyond a predetermined temperature range. Here, the predetermined temperature range is defined by an upper limit temperature T1 and a lower limit temperature T2 of the predetermined temperature range and is between the upper limit temperature T1 and the lower limit temperature T2 inclusive.

The following further describes the operation of the pump control unit 33, exchange membrane control unit 34, and valve control unit 35 included in the control apparatus 30 separately in the normal operation, the warm-up operation, and the restoration operation.

Note that the operation common to the normal operation, the warm-up operation, and the restoration operation is that the pump control unit 33, the exchange membrane control unit 34, and the valve control unit 35 repeatedly acquire the exchange membrane temperature with the temperature sensor 8 at predetermined time intervals. Furthermore, the pump control unit 33 acquires the inflow flow rate of the liquid to be processed flowing into the desalination apparatus 4 with the flow rate sensor 7 at predetermined time intervals. The exchange membrane control unit 34 acquires the first ion concentration with the first concentration sensor 9 at predetermined time intervals. The first ion concentration is the metal ion concentration of the first drainage discharged from the desalination apparatus 4 and flowing into the metal recovery apparatus 6. The metal ion concentration is referred to as a lithium ion concentration in the present embodiment, and the same applies hereinafter. Furthermore, the valve control unit 35 acquires the second ion concentration, which is the metal ion concentration of the second drainage discharged from the metal recovery apparatus 6, at predetermined time intervals with the second concentration sensor 10.

### 2.1 Operation in Normal Operation

First, the operation in the normal operation is to be described.

In the normal operation, the pump control unit 33 controls energization of the pump 2 so that the flow rate of the liquid to be processed flowing into the desalination apparatus 4 is a first flow rate F1 determined in advance. The first flow rate F1 is determined, for example, based on the desalination processing capacity of the desalination apparatus 4 (for example, the amount of water processed per hour). In addition to this, the first flow rate F1 may also be determined based on the processing capacity of the metal recovery apparatus 6.

Furthermore, in the normal operation, the exchange membrane control unit 34 controls the voltage applied to electrodes 5a and 5b of metal ion exchange membrane 5 (hereinafter also referred to as a membrane voltage) based on the first ion concentration, which is the metal ion concentration of the first drainage discharged from the desalination apparatus 4 and flowing into the metal recovery apparatus 6. For example, the exchange membrane control unit 34 increases the membrane voltage as the first ion concentration increases, thereby increasing the recovery rate of metal ions via the metal ion exchange membrane 5 (that is, the amount recovered per hour). In normal operation, the membrane voltage control is performed within a predetermined operating voltage range determined in advance (hereinafter also referred to as a predetermined voltage range) for the metal ion exchange membrane 5. Here, the predetermined voltage range is defined by an upper limit voltage V1 and a lower limit voltage V2 of the predetermined voltage range, and is between the upper limit voltage V1 and the lower and the lower limit voltage V2 inclusive.

When the exchange membrane temperature is equal to or lower than the upper limit temperature T1 of the predetermined temperature range, and when the second ion concentration, which is the metal ion concentration of the second drainage discharged from the metal recovery apparatus 6, is equal to or higher than a concentration threshold Cth determined in advance, the valve control unit 35 sets the control valve 13 so that the second drainage flows into the reflux path 11. Furthermore, in the normal operation, the valve control unit 35 sets the control valve 13 so that the second drainage flows to the drainage path 12 when the second ion concentration is less than the above concentration threshold Cth determined in advance. This allows the second drainage to be returned to the water intake pipe 17 and refluxed, so that the metal ions contained in the second drainage are allowed to flow into the metal recovery apparatus 6 again and recovered when the metal ion concentration in the second drainage is still higher than the concentration threshold Cth, thereby increasing the efficiency of metal recovery.

### 2.2 Operation in Warm-Up Operation

Next, the operation in the warm-up operation is to be described.

Control is typically made, in the warm-up operation of metal recovery apparatus that uses the metal ion exchange membrane, so that: the voltage applied to the electrodes of the metal ion exchange membrane is gradually increased; and the temperature of the metal ion exchange membrane is gradually and evenly raised due to the heat generated with ion permeation processing. Such control is performed because, if not performed, sudden increase in the voltage applied to the electrodes to the rated operational voltage range may increase the temperature of the main surface of the metal ion exchange membrane on the side of the liquid to be processed due to the heat generated with ion permeation processing, resulting in increase in temperature difference from the temperature of the main surface on the side of the recovery liquid, which side is opposite the side of the liquid to be processed, which temperature difference may decrease the metal ion recovery rate (amount recovered per hour), or may damage the cell (the assembly configured with the metal ion exchange membrane and electrodes) due to the temperature gradient.

In particular, in order that the metal ion recovery processing in the metal recovery apparatus 6 is performed stably and at the highest possible recovery rate even in the warm-up period, the metal recovery system 1 of the present embodiment controls the membrane voltage applied to the electrodes 5a and 5b of the metal ion exchange membrane 5, and controls the energization of the pump 2, to control the amount of the first drainage flowing into the metal recovery apparatus 6 connected downstream of the desalination apparatus 4 along the flow path of the liquid to be processed.

Specifically, the exchange membrane control unit 34 first controls the membrane voltage applied to the electrodes 5a and 5b of the metal ion exchange membrane 5 in the warm-up operation so that the temperature rise rate per hour of the exchange membrane temperature is within a range determined in advance. For example, the exchange membrane control unit 34 increases the membrane voltage with elapse of time at a predetermined voltage increase rate that is determined in advance as a value at which the temperature rise rate per hour of the exchange membrane temperature is within the range determined in advance.

Furthermore, the pump control unit 33 controls energization of the pump 2 in the warm-up operation so that the inflow flow rate of the liquid to be processed flowing into the desalination apparatus 4 is a second flow rate F2 that is smaller than the first flow rate F1 set in the normal operation described above. Therefore, the flow rate of the first drainage flowing from the desalination apparatus 4 to the metal recovery apparatus 6 also is smaller in the warm-up operation than the flow rate in the normal operation. This restricts the amount of the cold first drainage flowing into the metal recovery apparatus 6 in the period of the warm-up operation, allowing the temperature of the metal ion exchange membrane 5 to stably increase.

In particular, in the present embodiment, the above second flow rate F2 is set to a value that monotonically increases at a predetermined flow rate increase rate with respect to an increase in the exchange membrane temperature or elapse of time. This increases the amount of the first drainage flowing into the metal recovery apparatus 6 to allow increase in the recovery rate of metal ions in the warm-up operation, as the processing capacity of the ion permeation processing in the metal ion exchange membrane 5 increases with the exchange membrane temperature rise or elapse of time from the start of the warm-up operation.

Furthermore, in the present embodiment, the above flow rate increase rate is set to a larger value particularly when the exchange membrane temperature is equal to or higher than a temperature threshold T3 determined in advance, which is lower than the operating temperature range, than when the exchange membrane temperature is less than the temperature threshold T3. As a result, the flow rate increase rate is changed to a larger value as the exchange membrane temperature increases. Therefore, for example, when the increase rate in the processing capacity of the ion permeation processing in the metal ion exchange membrane 5 increases nonlinearly with respect to the increase in the exchange membrane temperature, the recovery rate of metal ions can be further improved.

In the present embodiment, the flow rate increase rate is set, for example, as an increase rate with respect to elapse of time in which the flow rate increase rate is set to a predetermined value k1 when the exchange membrane temperature is less than the temperature threshold T3, and is set to a predetermined value k2 larger than k1 when the exchange membrane temperature is equal to or higher than the temperature threshold T3.

Like the operation in the normal operation, in the warm-up operation in which the exchange membrane temperature is less than the lower limit temperature T2 of the predetermined temperature range, the valve control unit 35 sets the control valve 13 so that the second drainage flows to the reflux path 11 when the second ion concentration of the second drained liquid is equal to or higher than the concentration threshold Cth, and the valve control unit 35 sets the control valve 13 so that the second drainage flows to the drainage path 12 when the second ion concentration is less than the above concentration threshold Cth.

In the warm-up operation, the exchange membrane temperature of the metal ion exchange membrane 5 has not reached the predetermined temperature range, so the predetermined capacity for ion permeation processing is small. This causes the second ion concentration of the second drainage to be higher than the concentration in the normal operation. Therefore, the second ion concentration of the second drainage is higher in the period of the warm-up operation than the value in the normal operation, and therefore may remain equal to or higher than the concentration threshold Cth. As a result, the valve control unit 35 may maintain the state of the control valve 13 in such a state that the second drainage flows into the reflux path 11.

In the metal recovery apparatus 6, the second drainage is warmed by the metal ion exchange membrane 5 whose temperature has risen with elapse of time, and then is discharged. Therefore, leaving the second drainage flowing into the reflux path 11 in the period of the warm-up operation, as described above, gradually raise the temperature of the first drainage flowing into the metal recovery apparatus 6. This makes it easy to gradually raise the exchange membrane temperature of the metal ion exchange membrane 5.

### 2.3 Operation in Restoration Operation

Next, the operation in the restoration operation is to be described.

As described above, the restoration operation is started when the exchange membrane temperature of the metal ion exchange membrane 5 is higher than the predetermined temperature range.

In the restoration operation, the pump control unit 33 controls the energization of the pump 2 so that the flow rate of the liquid to be processed flowing into the desalination apparatus 4 is a third flow rate F3 that is higher than the first flow rate F1 in the normal operation. This increases the flow rate of the first drainage flowing into the metal recovery apparatus 6, to be able to quickly cool the metal ion exchange membrane 5.

Furthermore, the valve control unit 35 sets the control valve 13 so that the second drainage flows to the drainage path 12 in the restoration operation (that is, when the exchange membrane temperature of the metal ion exchange membrane 5 exceeds the predetermined temperature range). This prevents the second drainage warmed inside the metal recovery apparatus 6 from refluxing, becoming the warm first drainage and flowing back into the metal recovery apparatus 6, and allowing the metal ion exchange membrane 5 to be cooled more quickly.

The above operation in the pump control unit 33 and the valve control unit 35 quickly cools down the metal ion exchange membrane 5, which has reached a high temperature exceeding a predetermined temperature range. This allows the exchange membrane control unit 34 to continue the operation in the normal operation. In other words, the exchange membrane control unit 34 controls the membrane voltage applied to the electrodes 5a and 5b of the metal ion exchange membrane 5 within the predetermined voltage range based on the first ion concentration of the first drainage.

### 3. Example of Operation of Metal Recovery System

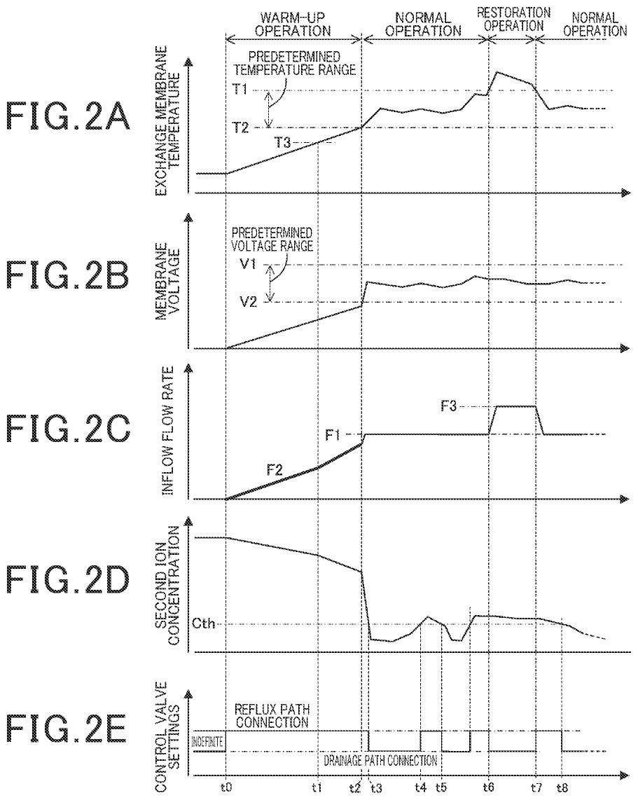

Next, an example of the operation of the metal recovery system 1 is to be described. FIGS. 2A to 2E are diagrams showing an example of the operation of the metal recovery system 1. FIGS. 2A to 2E show five graphs arranged in the up-down direction in the figure. From the top of the diagram, FIG. 2A is a graph showing the change in exchange membrane temperature of the metal ion exchange membrane 5 with respect to time, and FIG. 2B is a graph showing the change in the membrane voltage applied to the electrodes 5a and 5b of the metal ion exchange membrane 5 with respect to time. FIG. 2C is a graph showing the change in the inflow flow rate of the liquid to be processed flowing into the desalination apparatus 4 with respect to time, and FIG. 2D is a graph showing the change in the second ion concentration of the second drainage discharged from the metal recovery apparatus 6 with respect to time. FIG. 2E is a graph showing the change in the setting state of the control valve 13 with respect to time.

The graphs shown in FIGS. 2A, 2B, 2C, 2D, and 2E respectively have horizontal axes that are time axes representing the same time in elapse of time. Note that the reference characters denoting individual times are shown only on the time axis in FIG. 2E.

The exchange membrane temperature graph in FIG. 2A shows the predetermined temperature range defined as a range from the upper limit temperature T1 to the lower limit temperature T2 inclusive, and the temperature threshold T3.

The membrane voltage graph in FIG. 2B shows the predetermined voltage range defined as the range from the upper limit voltage V1 to the lower limit voltage V2 inclusive.

The control valve setting graph in FIG. 2E shows the setting state in which the second drainage flows to the reflux path 11 (hereinafter also referred to as reflux path connection) as a high level state, and shows a setting state in which the second drainage flows into the drainage path 12 (hereinafter also referred to as drainage path connection) as a low level state.

In FIGS. 2A to 2E, the metal recovery system 1 stops operation in the initial state, and starts operation at time t0. At time t0, the exchange membrane temperature is lower than the predetermined temperature range, so the control apparatus 30 starts the warm-up operation.

In the control apparatus 30 that has started the warm-up operation, since the second ion concentration of the second drainage from the metal recovery apparatus 6 exceeds the concentration threshold Cth at time t0 (FIG. 2D), the valve control unit 35 first sets the control valve 13 to the reflux path connection state (FIG. 2E). Here, the state of the control valve 13 in the period up to time t0 may be indefinite. For example, the state of the control valve 13 in the period up to time t0 can be a state set when the metal recovery system 1 stopped operation the last time.

The exchange membrane control unit 34 of the control apparatus 30 starts applying a membrane voltage to the electrodes 5a and 5b of the metal ion exchange membrane 5 at time t0, and increases membrane voltage with elapse of time (FIG. 2B) at a predetermined voltage increase rate determined in advance so that the temperature rise rate per hour of the exchange membrane temperature is within the range determined in advance,

Furthermore, the pump control unit 33 of the control apparatus 30 controls the energization of the pump 2 (FIG. 2C) so that the inflow flow rate of the liquid to be processed flowing into the desalination apparatus 4 is the second flow rate F2 that is smaller than the first flow rate F1 set in the normal operation. Here, in the present embodiment, the second flow rate F2 is set to a value that monotonically increases with respect to elapse of time at a predetermined flow rate increase rate. Specifically, the pump control unit 33 sets the flow rate increase rate to the predetermined value k1 from time t0 to t1 when the exchange membrane temperature is less than the temperature threshold T3. Furthermore, the pump control unit 33 sets the flow rate increase rate to a predetermined value k2, which is larger than the predetermined value k1, at time t1 when the exchange membrane temperature reaches the temperature threshold T3. Here in FIG. 2C, the second flow rate F2 is indicated in a line part shown by a thick line in the diagram for a period from time t0 to time t2, which is to be described below.

The above operation gradually decreases the second ion concentration of the second drainage from the metal recovery apparatus 6 from time t0 with the period of time of applying the membrane voltage (FIG. 2D).

Furthermore, the above warm-up operation causes the exchange membrane temperature to gradually increase. Then, when the exchange membrane temperature reaches the lower limit temperature T2 of the predetermined temperature range at time t2, the warm-up operation ends and the normal operation starts (FIG. 2A).

In the normal operation starting from time t2, the exchange membrane control unit 34 controls the membrane voltage within the predetermined voltage range. As described above, the exchange membrane control unit 34 controls the membrane voltage based on the first ion concentration in the first drainage of the desalination apparatus 4 in the normal operation. In this manner, the membrane voltage can increase at time t2 in response to the control in the exchange membrane control unit 34 switching from warm-up operation to normal operation at time t2 (FIG. 2B).

Furthermore, when the normal operation starts at time t2, the pump control unit 33 controls the pump 2 so that the flow rate of the liquid to be processed flowing into the desalination apparatus 4 becomes the first flow rate F1. As a result, the above inflow flow rate can increase from the second flow rate F2 to the first flow rate F1 at time t2 (FIG. 2C).

At time t2, when the exchange membrane control unit 34 starts controlling the membrane voltage within the predetermined voltage range based on the first ion concentration, the throughput of the ion permeation processing in the metal ion exchange membrane 5 increases at once, and the second ion concentration in the second drainage rapidly decreases (FIG. 2D). Then, at time t3 when the second ion concentration becomes less than the concentration threshold Cth, the valve control unit 35 sets the control valve 13 to connect to the drainage path.

After that, for example, when the second ion concentration becomes equal to or higher than the concentration threshold Cth at time t4 due to fluctuations in the metal ion content of the liquid to be processed supplied by water intake from the sea S (FIG. 2D), the valve control unit 35 sets the control valve 13 to the reflux path connection state (FIG. 2E). Thereby, the second drainage mixes with the liquid to be processed, flows into the metal recovery apparatus 6 again as the first drainage, and metal ions contained in the second drainage will be recovered.

Thereafter, when the second ion concentration becomes less than the concentration threshold Cth at time t5 (FIG. 2D), the valve control unit 35 sets the control valve 13 to the drainage path connection state (FIG. 2E). Thereafter, the above normal operation is repeated while the exchange membrane temperature is maintained within the predetermined operating range.

Further time elapses, and for example, when the current flowing between the electrodes 5a and 5b of the metal ion exchange membrane 5 increases due to fluctuations in the content of metal ions in the first drainage, to cause the exchange membrane temperature to rise and exceed the upper limit temperature T1 of the predetermined temperature range at time t6 (FIG. 2A), the control apparatus 30 starts the restoration operation.

In the restoration operation, the pump control unit 33 first controls the pump 2 so that the flow rate of the liquid to be processed flowing into the desalination apparatus 4 becomes the third flow rate F3, which is larger than the first flow rate F1 (see FIG. 2C)). Furthermore, the valve control unit 35 sets the control valve 13 to drainage path connection so that the warmed second drainage does not merge with the liquid to be processed (FIG. 2E). Note that, when the control valve 13 has already been set to the drainage path connection because the second ion concentration is less than Cth before time t6, the valve control unit 35 maintains setting of the drainage path connection.

As a result of the above operation, when the exchange membrane temperature falls on or below the upper limit temperature T1 of the predetermined temperature range at subsequent time t7, the control apparatus 30 returns to the normal operation. In other words, the pump control unit 33 controls the pump 2 so that the inflow flow rate of the liquid to be processed into the desalination apparatus 4 is the first flow rate F1 (FIG. 2C), and the valve control unit 35 sets the control valve 13 to the drainage path connection or the reflux path connection depending on whether the second ion concentration is less than the concentration threshold

Cth (FIG. 2E). In the example of FIGS. 2A to 2E, the valve control unit 35 sets the control valve 13 to reflux path connection because the second ion concentration exceeds Cth at time t7.

After returning to the normal operation at time t7, the control apparatus 30 repeats the operation in time t1 to t6. For example, the valve control unit 35 switches the control valve 13 to drainage path connection in response to the second ion concentration becoming less than the concentration threshold Cth at time t8 (FIGS. 2D and 2E).

### 4. Processing Procedure in Metal Recovery System

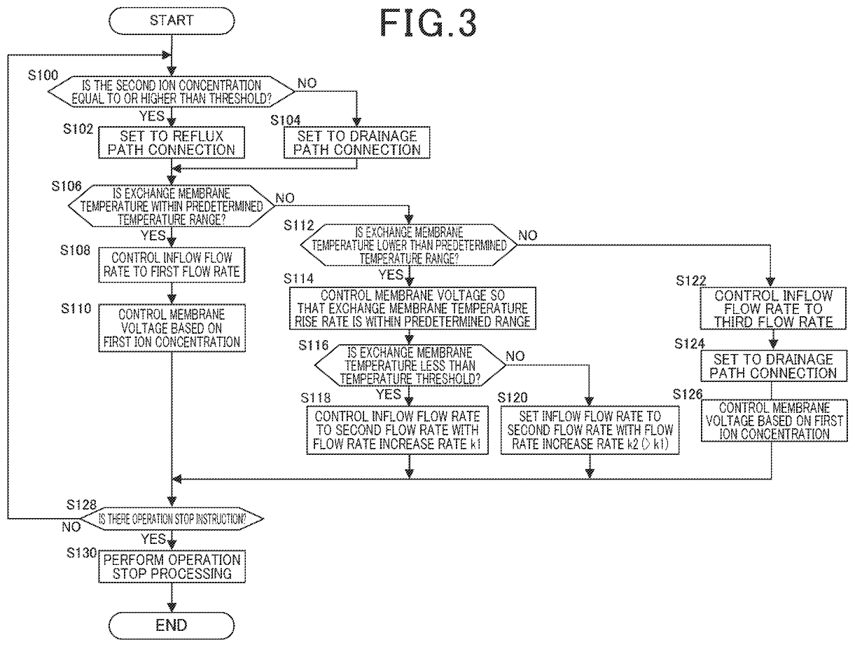

The following describes a processing procedure of the metal recovery method performed by the metal recovery system 1. FIG. 3 is a flowchart showing a processing procedure of the metal recovery method executed by the processor 31 of the control apparatus 30, which is the computer of the metal recovery system 1. The processing shown in FIG. 3 starts in response to an instruction for starting operation of the metal recovery system 1 input from the operator via the operator terminal 40 when the power of the individual apparatuses including the pump 2 and the control apparatus 30 configuring the metal recovery system 1 is turned on, or in a state in which the power of the individual apparatuses is turned on.

Note that, in parallel with the processing shown in FIG. 3, the pump control unit 33, exchange membrane control unit 34, and valve control unit 35 of the control apparatus 30 repeatedly acquire the exchange membrane temperature at predetermined time intervals with the temperature sensor 8. Furthermore, the pump control unit 33 acquires the inflow flow rate of the liquid to be processed flowing into the desalination apparatus 4 with the flow rate sensor 7 at predetermined time intervals. The exchange membrane control unit 34 acquires the first ion concentration, which is the metal ion concentration of the first drainage, at predetermined time intervals with the first concentration sensor 9. Furthermore, the valve control unit 35 acquires the second ion concentration, which is the metal ion concentration of the second drainage, at predetermined time intervals with the second concentration sensor 10.

When the process starts in FIG. 3, the valve control unit 35 of the control apparatus 30 first determines whether the current second ion concentration is equal to or higher than the concentration threshold Cth (S100). Then, when the current second ion concentration is equal to or higher than the concentration threshold Cth (S100, YES), the valve control unit 35 sets the control valve 13 to be reflux path connection (S102). Contrarily, when the current second ion concentration is less than the concentration threshold Cth (S100, NO), the valve control unit 35 sets the control valve 13 to drainage path connection (S104).

Next, the pump control unit 33 and the exchange membrane control unit 34 determine whether the exchange membrane temperature is within the predetermined temperature range (S106). Then, when the exchange membrane temperature is within the predetermined temperature range (S106, YES), the control apparatus 30 performs the normal operation. In other words, the pump control unit 33 controls the energization of the pump 2 so that the flow rate of the liquid to be processed flowing into the desalination apparatus 4 is the first flow rate F1 (S108). Furthermore, the exchange membrane control unit 34 controls the membrane voltage applied to the electrodes 5a and 5b of the metal ion exchange membrane 5 of the metal recovery apparatus 6 within the predetermined voltage range based on the first ion concentration of the first drainage (S110).

After that, the exchange membrane control unit 34 determines whether there is an operation stop instruction (S128). Here, the operation stop instruction may be an operation stop instruction input by the operator via the operator terminal 40, or turning off of the power of the control apparatus 30.

When there is no operation stop instruction (S128, NO), the exchange membrane control unit 34 returns the process to step S100. Contrarily, when there is an operation stop instruction (S128, YES), the pump control unit 33, exchange membrane control unit 34, and valve control unit 35 perform operation stop processing (S130), and then end the processing. In the operation stop processing, for example, the pump control unit 33 stops energizing the pump 2, the exchange membrane control unit 34 stops outputting the membrane voltage, and the valve control unit 35 sets the control valve 13 to drainage path connection.

Furthermore, when the exchange membrane temperature is not within the predetermined temperature range in step S106 (S106, NO), the pump control unit 33 and the exchange membrane control unit 34 determine whether the exchange membrane temperature is lower than the predetermined temperature range (S112). Then, when the exchange membrane temperature is lower than the predetermined temperature range (S112, YES), that is, when the temperature is lower than the lower limit temperature T2 of the predetermined temperature range, the control apparatus 30 performs a warm-up operation. In other words, the exchange membrane control unit 34 controls the membrane voltage applied to the electrodes 5a and 5b of the metal ion exchange membrane 5 so that the temperature rise rate per hour of the exchange membrane temperature is within the range determined in advance (S114). For example, in the present embodiment, the exchange membrane control unit 34 controls the membrane voltage so that the membrane voltage increases with elapse of time at a predetermined voltage increase rate that is determined in advance as a value at which the temperature rise rate per hour of the exchange membrane temperature is within the range determined in advance.

Furthermore, the pump control unit 33 determines whether the exchange membrane temperature is less than a temperature threshold T3 that is lower than the predetermined temperature range (that is, lower than the lower limit temperature T2) (S116). Then, when the exchange membrane temperature is less than the temperature threshold T3 (S116, YES), the pump control unit 33 controls the pump 2 so that the flow rate of the liquid to be processed flowing into the desalination apparatus 4 increases at a flow rate increase rate of a predetermined value k1 with respect to time (S118). After that, the pump control unit 33 moves the processing to step S128.

Contrarily, in step S116, when the exchange membrane temperature is equal to or higher than the temperature threshold T3 (S116, NO), the pump control unit 33 controls the pump 2 so that the above inflow flow rate increases with respect to time at a flow rate increase rate of a predetermined value k2 that is larger than the above predetermined value k1 (S120). After that, the pump control unit 33 moves the processing to step S128.

Contrarily, when the exchange membrane temperature is not within the predetermined temperature range (S106, NO) and is not lower than the predetermined temperature range (S112, NO), that is, when the exchange membrane temperature is higher than the predetermined temperature range, the control apparatus 30 performs the restoration operation. In other words, the pump control unit 33 controls the energization of the pump 2 so that the flow rate of the liquid to be processed flowing into the desalination apparatus 4 becomes the third flow rate F3, which is larger than the first flow rate F1 (S122). Furthermore, the valve control unit 35 sets the control valve 13 to drainage path connection (S124). Furthermore, the exchange membrane control unit 34 controls the membrane voltage applied to the electrodes 5a and 5b of the metal ion exchange membrane 5 of the metal recovery apparatus 6 within the predetermined voltage range based on the first ion concentration of the first drainage (S126). After that, the exchange membrane control unit 34 moves the process to step S128.

Here, in FIG. 3, steps S108 and S110 respectively correspond to a first pump control step and a first exchange membrane control step in the present disclosure. Furthermore, steps S100, S102, and S104 correspond to a reflux control step in the present disclosure. Furthermore, step S114 corresponds to a second exchange membrane control step in the present disclosure. Furthermore, steps S118 and S120 correspond to a second pump control step in the present disclosure. Furthermore, step S122 corresponds to a third pump control step.

### 5. Other Embodiments

Although the flow rate increase rate of the second flow rate F2 in the warm-up operation is the increase rate with respect to elapse of time in the above-described embodiment, the flow rate increase rate may be an increase rate with respect to the rise in the exchange membrane temperature.

Furthermore, in the embodiment described above, the exchange membrane control unit 34 controls the membrane voltage applied to the electrodes 5a and 5b of the metal ion exchange membrane 5, but the exchange membrane control unit 34 may control the current value energizing the electrodes 5a and 5b.

Furthermore, although the liquid to be processed by the metal recovery system 1 is seawater in the above-described embodiment, the liquid may be any liquid containing metal ions. For example, the liquid to be processed may be a drainage of an old battery electrolyte (battery treatment liquid). For example, the metal recovery system 1 can recover lithium from the Li battery treatment liquid that is the liquid to be processed.

Furthermore, the metal recovery system 1 is designed to recover lithium contained in seawater in the embodiment described above, but the configuration of the metal recovery system 1 can be used to recover any metal that can be extracted using an ion exchange membrane. For example, the metal recovery system 1 can use a metal ion exchange membrane suitable for the target metal ions in place of the metal ion exchange membrane 5 to recover metals such as sodium (Na), potassium (K), magnesium (Mg), and calcium (Ca) contained in seawater, and to recover metals such as nickel (Ni), cobalt (Co), and manganese (Mn) contained in Li battery treatment solution.

Note that the present invention is not limited to the configurations of the above-described embodiments, and can be implemented in various aspects without departing from the spirit of the present invention.

### 6. Configurations Supported By the Above Embodiments

The above-described embodiments support the following configurations.

### Configuration 1

A metal recovery system, including: a pump that pressurizes and sends out liquid to be processed; a desalination apparatus that obtains freshwater with a reverse osmosis membrane from the liquid to be processed pressurized by the pump; a metal recovery apparatus that recovers metal ions of a targeted specific metal from first drainage that is drainage liquid discharged from the desalination apparatus out of the liquid to be processed, using a metal ion exchange membrane; a flow rate sensor that detects an inflow flow rate of the liquid to be processed flowing from the pump into the desalination apparatus; a temperature sensor that detects an exchange membrane temperature that is a temperature of the metal ion exchange membrane; a first concentration sensor that detects a first ion concentration that is a metal ion concentration of the specific metal in the first drainage; and a control apparatus that controls: energization of electrodes that apply an electric field to the metal ion exchange membrane; and energization of the pump, in which the control apparatus includes: a pump control unit that controls energization of the pump so that the inflow flow rate is a first flow rate, determined in advance, when the exchange membrane temperature is within a predetermined temperature range determined in advance; and an exchange membrane control unit that controls energization of the electrodes based on the first ion concentration when the exchange membrane temperature is within a predetermined temperature range determined in advance.

According to the metal recovery system of Configuration 1, the desalination apparatus extracts freshwater from the liquid to be processed, and the metal recovery apparatus recovers metal ions from the first drainage of the desalination apparatus, which has a rich metal ion content per unit volume. This allows simultaneously achieving desalination of the liquid to be processed and metal recovery from the liquid to be processed. Furthermore, according to the metal recovery system of Configuration 1, the system allows controlling: the inflow amount of the liquid to be processed into the desalination apparatus and the inflow amount of the first drainage into the metal recovery apparatus with one pump; and energization of the electrodes of the metal ion exchange membrane based on the first ion concentration, which is the metal ion concentration in the first drainage. Therefore, metal ions can be efficiently recovered in the metal recovery apparatus with a simple system configuration.

### Configuration 2

The metal recovery system according to Configuration 1, further including: a second concentration sensor that detects a second ion concentration that is a metal ion concentration of the specific metal in second drainage that is drainage liquid discharged from the metal recovery apparatus out of the first drainage; a drainage path that drains the second drainage; a reflux path that refluxes the second drainage to a suction port of the pump; and a control valve that controls whether the second drainage flows into the reflux path or into the drainage path, in which the control apparatus further includes a valve control unit that controls operation of the control valve, and the valve control unit: controls the control valve so that the second drainage flows to the reflux path when the second ion concentration is equal to or higher than a concentration threshold determined in advance and the exchange membrane temperature is equal to or lower than an upper limit temperature of the predetermined temperature range, and controls the control valve so that the second drainage flows to the drainage path when the second ion concentration is less than a concentration threshold determined in advance or the exchange membrane temperature is above the predetermined temperature range.

According to the metal recovery system of Configuration 2, when the metal ion concentration in the second drainage discharged from the metal recovery apparatus is still higher than the concentration threshold, the second drainage can be refluxed to further recover metal ions contained in the second drainage in the metal recovery apparatus. Therefore, the recovery efficiency of metal ions can be further improved.

### Configuration 3

The metal recovery system according to Configuration 1 or 2, in which the pump control unit controls energization of the pump so that the inflow flow rate is a second flow rate that is lower than the first flow rate when the exchange membrane temperature is lower than the predetermined temperature range, and the exchange membrane control unit controls energization of the electrodes so that a temperature rise rate per hour of the exchange membrane temperature is within a range, determined in advance, when the exchange membrane temperature is lower than the predetermined temperature range.

According to the metal recovery system of Configuration 3, in the warm-up operation period until the exchange membrane temperature reaches the predetermined temperature range suitable for ion permeation processing, the amount of cold first drainage flowing into the metal recovery apparatus is restricted so that the temperature of the metal ion exchange membrane can slowly and stably increase, while metal ions can also be recovered by gradually increasing the throughput of the ion permeation processing of the metal ion exchange membrane.

### Configuration 4

The metal recovery system according to Configuration 3, in which the second flow rate is set to a value that monotonically increases at a predetermined flow rate increase rate with respect to the exchange membrane temperature or time, and when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

According to the metal recovery system of Configuration 4, the flow rate increase rate is changed to a larger value as the exchange membrane temperature increases. Therefore, for example, when the increase rate in the processing capacity of the ion permeation processing in the metal ion exchange membrane 5 increases nonlinearly with respect to the increase in the exchange membrane temperature, the recovery rate of metal ions can be further improved.

### Configuration 5

The metal recovery system according to any of Configurations 1 to 4, in which the pump control unit controls energization of the pump so that the inflow flow rate is a third flow rate that is higher than the first flow rate when the exchange membrane temperature is higher than the predetermined temperature range.

According to the metal recovery system of Configuration 5, when an abnormal state occurs in which the exchange membrane temperature rises above the predetermined temperature range suitable for ion permeation processing, increase in the flow rate of the liquid to be processed flowing into the desalination apparatus can increase the flow rate of the first drainage flowing into the metal recovery apparatus, to quickly cool the exchange membrane temperature to a temperature within the predetermined temperature range.

### Configuration 6

The metal recovery system according to any of Configurations 1 to 5, in which the specific metal is lithium.

According to the metal recovery system of Configuration 6, lithium, which is industrially important as a battery material, can be efficiently recovered.

### Configuration 7

The metal recovery system according to any of Configurations 1 to 6, in which the liquid to be processed is seawater.

According to the metal recovery system of Configuration 7, it is possible to efficiently recover metal resources contained in vast quantities in seawater.

### Configuration 8

A metal recovery method executed by a computer of a metal recovery system including: a pump that pressurizes and sends out liquid to be processed; a desalination apparatus that obtains freshwater with a reverse osmosis membrane from the liquid to be processed pressurized by the pump; a metal recovery apparatus that recovers metal ions of a targeted specific metal from first drainage that is drainage liquid discharged from the desalination apparatus out of the liquid to be processed, using a metal ion exchange membrane; a flow rate sensor that detects an inflow flow rate of the liquid to be processed flowing from the pump into the desalination apparatus; a temperature sensor that detects an exchange membrane temperature that is a temperature of the metal ion exchange membrane; a first concentration sensor that detects a first ion concentration that is a metal ion concentration of the specific metal in the first drainage; a control apparatus that controls: energization of electrodes that apply an electric field to the metal ion exchange membrane; and energization of the pump, the method including: a first pump control step of controlling energization of the pump so that the inflow flow rate is a predetermined first flow rate when the exchange membrane temperature is within a temperature range determined in advance; and a first exchange membrane control step of controlling energization of the electrodes based on the first ion concentration when the exchange membrane temperature is within a predetermined temperature range determined in advance.

According to the metal recovery method of Configuration 8, the desalination apparatus extracts freshwater from the liquid to be processed, and the metal recovery apparatus recovers metal ions from the first drainage of the desalination apparatus, which has a rich metal ion content per unit volume. This allows simultaneously achieving desalination of the liquid to be processed and metal recovery from the liquid to be processed. Furthermore, according to the metal recovery method of Configuration 8, the configuration allows controlling: the inflow amount of the liquid to be processed into the desalination apparatus and the inflow amount of the first drainage into the metal recovery apparatus with one pump; and energization of the electrodes of the metal ion exchange membrane based on the first ion concentration, which is the metal ion concentration of the first drainage. Therefore, metal ions can be efficiently recovered in the metal recovery apparatus with a simple system configuration.

### Configuration 9

The metal recovery method according to Configuration 8, the metal recovery system further including: a second concentration sensor that detects a second ion concentration that is a metal ion concentration of the specific metal in second drainage that is drainage liquid discharged from the metal recovery apparatus out of the first drainage; a drainage path that drains the second drainage; a reflux path that refluxes the second drainage to a suction port of the pump; and a control valve that controls whether the second drainage flows into the reflux path or into the drainage path, the method further including a reflux control step of: controlling the control valve so that the second drainage flows to the reflux path when the second ion concentration is equal to or higher than a concentration threshold determined in advance and the exchange membrane temperature is equal to or lower than an upper limit temperature of the predetermined temperature range; and controlling the control valve so that the second drainage flows to the drainage path when the second ion concentration is less than a concentration threshold determined in advance or the exchange membrane temperature is above the predetermined temperature range.

According to the metal recovery method of Configuration 9, when the metal ion concentration in the second drainage discharged from the metal recovery apparatus is still higher than the concentration threshold, the second drainage can be refluxed to further recover metal ions contained in the second drainage in the metal recovery apparatus. Therefore, the recovery efficiency of metal ions can be further improved.

### Configuration 10

The metal recovery method according to Configuration 8 or 9, further including: a second pump control step of controlling energization of the pump so that the inflow flow rate is a second flow rate that is lower than the first flow rate when the exchange membrane temperature is lower than the predetermined temperature range; and a second exchange membrane control step of controlling energization of the electrodes so that a temperature rise rate per hour of the exchange membrane temperature is within a range, determined in advance, when the exchange membrane temperature is lower than the predetermined temperature range.

According to the metal recovery method of Configuration 10, in the warm-up operation period until the exchange membrane temperature reaches the predetermined temperature range suitable for ion permeation processing, the amount of cold first drainage flowing into the metal recovery apparatus is restricted so that the temperature of the metal ion exchange membrane can slowly and stably increase, while metal ions can also be recovered by gradually increasing the throughput of the ion permeation processing of the metal ion exchange membrane.

### Configuration 11

The metal recovery method according to Configuration 10, in which the second flow rate is set to a value that monotonically increases at a predetermined flow rate increase rate with respect to the exchange membrane temperature or time, and when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

According to the metal recovery method of Configuration 11, the flow rate increase rate is changed to a larger value as the exchange membrane temperature increases. Therefore, for example, when the increase rate in the processing capacity of the ion permeation processing in the metal ion exchange membrane 5 increases nonlinearly with respect to the increase in the exchange membrane temperature, the recovery rate of metal ions can be further improved.

### Configuration 12

The metal recovery method according to any of Configurations 8 to 11, further including a third pump control step of controlling energization of the pump so that the inflow flow rate is a third flow rate that is higher than the first flow rate when the exchange membrane temperature is higher than the predetermined temperature range.

According to the metal recovery method of Configuration 12, when an abnormal state occurs in which the exchange membrane temperature rises above the predetermined temperature range suitable for ion permeation processing, increase in the flow rate of the liquid to be processed flowing into the desalination apparatus can increase the flow rate of the first drainage flowing into the metal recovery apparatus, to quickly cool the exchange membrane temperature to a temperature within the predetermined temperature range.

### REFERENCE SIGNS LIST

1 . . . metal recovery system, 2 . . . pump, 3 . . . reverse osmosis membrane, 4 . . . desalination apparatus, 5 . . . metal ion exchange membrane, 5a, 5b . . . electrode, 6 . . . metal recovery apparatus, 7 . . . flow rate sensor, 8 . . . temperature sensor, 9 . . . first concentration sensor, 10 . . . second concentration sensor, 11 . . . reflux path, 12 . . . drainage path, 13 . . . control valve, 14 . . . freshwater storage tank, 15 . . . recovery liquid storage tank, 16 . . . mesh filter, 17 . . . water intake pipe, 18 . . . inflow pipe, 19 . . . communication pipe, 20 . . . drainage pipe, 30 . . . control apparatus, 31 . . . processor, 32 . . . memory, 33 . . . pump control unit, 34 . . . exchange membrane control unit, 35 . . . valve control unit, 40 . . . operator terminal.

What is claimed is:

1. A metal recovery system, comprising:
a pump that pressurizes and sends out liquid to be processed;
a desalination apparatus that obtains freshwater with a reverse osmosis membrane from the liquid to be processed pressurized by the pump;
a metal recovery apparatus that recovers metal ions of a targeted specific metal from first drainage that is drainage liquid discharged from the desalination apparatus out of the liquid to be processed, using a metal ion exchange membrane;
a flow rate sensor that detects an inflow flow rate of the liquid to be processed flowing from the pump into the desalination apparatus;
a temperature sensor that detects an exchange membrane temperature that is a temperature of the metal ion exchange membrane;
a first concentration sensor that detects a first ion concentration that is a metal ion concentration of the specific metal in the first drainage; and
a control apparatus that controls: energization of electrodes that apply an electric field to the metal ion exchange membrane; and energization of the pump,
wherein the control apparatus includes:
a pump control unit that controls energization of the pump so that the inflow flow rate is a first flow rate, determined in advance, when the exchange membrane temperature is within a predetermined temperature range determined in advance; and
an exchange membrane control unit that controls energization of the electrodes based on the first ion concentration when the exchange membrane temperature is within a predetermined temperature range determined in advance.

2. The metal recovery system according to claim 1, further comprising:
a second concentration sensor that detects a second ion concentration that is a metal ion concentration of the specific metal in second drainage that is drainage liquid discharged from the metal recovery apparatus out of the first drainage;
a drainage path that drains the second drainage;
a reflux path that refluxes the second drainage to a suction port of the pump; and
a control valve that controls whether the second drainage flows into the reflux path or into the drainage path,
wherein the control apparatus further includes a valve control unit that controls operation of the control valve, and
the valve control unit:
controls the control valve so that the second drainage flows to the reflux path when the second ion concentration is equal to or higher than a concentration threshold determined in advance and the exchange membrane temperature is equal to or lower than an upper limit temperature of the predetermined temperature range; and
controls the control valve so that the second drainage flows to the drainage path when the second ion concentration is less than a concentration threshold determined in advance or the exchange membrane temperature is above the predetermined temperature range.

3. The metal recovery system according to claim 1, wherein
the pump control unit controls energization of the pump so that the inflow flow rate is a second flow rate that is lower than the first flow rate when the exchange membrane temperature is lower than the predetermined temperature range, and
the exchange membrane control unit controls energization of the electrodes so that a temperature rise rate per hour of the exchange membrane temperature is within a range, determined in advance, when the exchange membrane temperature is lower than the predetermined temperature range.

4. The metal recovery system according to claim 3, wherein
the second flow rate is set to a value that monotonically increases at a predetermined flow rate increase rate with respect to the exchange membrane temperature or time, and
when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

5. The metal recovery system according to claim 1, wherein the pump control unit controls energization of the pump so that the inflow flow rate is a third flow rate that is higher than the first flow rate when the exchange membrane temperature is higher than the predetermined temperature range.

6. The metal recovery system according to claim 1, wherein the specific metal is lithium.

7. The metal recovery system according to claim 1, wherein the liquid to be processed is seawater.

8. A metal recovery method executed by a computer of a metal recovery system including: a pump that pressurizes and sends out liquid to be processed; a desalination apparatus that obtains freshwater with a reverse osmosis membrane from the liquid to be processed pressurized by the pump; a metal recovery apparatus that recovers metal ions of a targeted specific metal from first drainage that is drainage liquid discharged from the desalination apparatus out of the liquid to be processed, using a metal ion exchange membrane; a flow rate sensor that detects an inflow flow rate of the liquid to be processed flowing from the pump into the desalination apparatus; a temperature sensor that detects an exchange membrane temperature that is a temperature of the metal ion exchange membrane; a first concentration sensor that detects a first ion concentration that is a metal ion concentration of the specific metal in the first drainage; a control apparatus that controls: energization of electrodes that apply an electric field to the metal ion exchange membrane; and energization of the pump, the method comprising:
a first pump control step of controlling energization of the pump so that the inflow flow rate is a predetermined first flow rate when the exchange membrane temperature is within a temperature range determined in advance; and
a first exchange membrane control step of controlling energization of the electrodes based on the first ion concentration when the exchange membrane temperature is within a predetermined temperature range determined in advance.

9. The metal recovery method according to claim 8, the metal recovery system further including: a second concentration sensor that detects a second ion concentration that is a metal ion concentration of the specific metal in second drainage that is drainage liquid discharged from the metal recovery apparatus out of the first drainage; a drainage path that drains the second drainage; a reflux path that refluxes the second drainage to a suction port of the pump; and a control valve that controls whether the second drainage flows into the reflux path or into the drainage path, the method further comprising
a reflux control step of: controlling the control valve so that the second drainage flows to the reflux path when the second ion concentration is equal to or higher than a concentration threshold determined in advance and the exchange membrane temperature is equal to or lower than an upper limit temperature of the predetermined temperature range; and controlling the control valve so that the second drainage flows to the drainage path when the second ion concentration is less than a concentration threshold determined in advance or the exchange membrane temperature is above the predetermined temperature range.

10. The metal recovery method according to claim 8, further comprising:
a second pump control step of controlling energization of the pump so that the inflow flow rate is a second flow rate that is lower than the first flow rate when the exchange membrane temperature is lower than the predetermined temperature range; and
a second exchange membrane control step of controlling energization of the electrodes so that a temperature rise rate per hour of the exchange membrane temperature is within a range, determined in advance, when the exchange membrane temperature is lower than the predetermined temperature range.

11. The metal recovery method according to claim 10, wherein
the second flow rate is set to a value that monotonically increases at a predetermined flow rate increase rate with respect to the exchange membrane temperature or time, and
when the exchange membrane temperature is equal to or higher than a temperature threshold, determined in advance, that is lower than the predetermined temperature range, the flow rate increase rate is set to a larger value than when the exchange membrane temperature is less than the temperature threshold determined in advance.

12. The metal recovery method according to claim 8, further comprising a third pump control step of controlling energization of the pump so that the inflow flow rate is a third flow rate that is higher than the first flow rate when the exchange membrane temperature is higher than the predetermined temperature range.
